(19) United States
(12) Patent Application Publication
(10) Pub. No.: US 2014/0204769 A1
(43) Pub. Date: Jul. 24, 2014

(54) FAILURE DETECTION APPARATUS AND METHOD

(71) Applicant: KABUSHIKI KAISHA TOSHIBA, Tokyo (JP)

(72) Inventors: Tatsuma HIRANO, Tokyo (JP); Ren SAKATA, Yokohama-shi (JP); Cam Ly NGUYEN, Yokohama-shi (JP)

(73) Assignee: KABUSHIKI KAISHA TOSHIBA, Tokyo (JP)

(21) Appl. No.: 14/161,124

(22) Filed: Jan. 22, 2014

(30) Foreign Application Priority Data
Jan. 23, 2013 (JP) 2013-010283

(51) Int. Cl. H04W 24/00

(52) U.S. Cl. CPC H04W 24/00
USPC 370/245

(57) ABSTRACT

According to one embodiment, a failure detection apparatus includes a communicator, a selector, an execution unit, and a determiner. The communicator communicates with a wireless terminal mounted on a moving object via at least one of first bridge devices located at predetermined positions. The selector selects second bridge devices from the first bridge devices. The execution unit executes test connections to the wireless terminal using the second bridge devices. The determiner determines that the wireless terminal is inoperative if the test connection via any of the second bridge devices has failed.

### CROSS-REFERENCE TO RELATED APPLICATIONS

This application is based upon and claims the benefit of priority from Japanese Patent Application No. 2013-010283, filed Jan. 23, 2013, the entire contents of which are incorporated herein by reference.

### FIELD

Embodiments described herein relate generally to a failure detection apparatus and method, which detect a failure in wireless equipment.

### BACKGROUND

A train control system in which a wayside control device as ground equipment controls the operation of trains using wireless communications is known. In this train control system, wireless base stations are connected to the wayside control device by wired connections, and the wayside control device communicates with wireless terminals mounted on trains via these wireless base stations. In such train control system using wireless communications, communications may often fail due to the attenuation of radio field intensity caused by propagation loss and fading in air, even when wireless devices such as the wireless base stations and the wireless terminals mounted on trains are free from any failure.

It is important for a wireless communication system such as the aforementioned train control system to identify whether or not a cause of a communication failure is a failure of a wireless device.

### BRIEF DESCRIPTION OF THE DRAWINGS

FIG. 1 is a schematic block diagram showing a train control system according to the first embodiment;

FIG. 2 is a schematic block diagram showing a train shown in FIG. 1;

FIG. 3 is a schematic block diagram showing a wayside control device (failure detection apparatus) shown in FIG. 1;

FIG. 4 is a flowchart showing an example of the failure detection sequence according to the first embodiment;

FIG. 5 is a table showing an example of an inoperative-equipment determination method according to the first embodiment;

FIG. 6 is a flowchart showing an example of the failure detection sequence according to the second embodiment;

FIG. 7 is a table showing an example of an inoperative-equipment determination method according to the second embodiment;

FIG. 8 is a schematic block diagram showing a train control system according to the fourth embodiment;

FIG. 9 is a schematic flowchart showing a failure detection method according to the fourth embodiment;

FIG. 10 is a schematic block diagram showing a train control system according to the fifth embodiment;

FIG. 11 is a flowchart showing an example of the failure detection sequence according to the fifth embodiment;

FIG. 12 is a flowchart showing another example of the failure detection sequence according to the fifth embodiment;

FIG. 13 is a flowchart showing an example of the failure detection sequence according to the sixth embodiment;

FIG. 14 is a schematic block diagram showing a robot control system according to the seventh embodiment; and

FIG. 15 is a flowchart showing an example of the failure detection sequence according to the seventh embodiment.

### DETAILED DESCRIPTION

According to one embodiment, a failure detection apparatus includes a communicator, a selector, an execution unit, and a determiner. The communicator is configured to communicate with a wireless terminal mounted on a moving object via at least one of first bridge devices located at predetermined positions. The selector is configured to select second bridge devices from the first bridge devices. The execution unit is configured to execute test connections to the wireless terminal using the second bridge devices. The determiner is configured to determine that the wireless terminal is inoperative if the test connection via any of the second bridge devices has failed.

A failure detection apparatus and method according to embodiments will be described hereinafter with reference to the accompanying drawings. The failure detection apparatus according to the embodiments is applicable to, for example, a train control system, robot control system, sensor network system, intelligent transport system (ITS), and the like. In the following embodiments, like reference numerals denote like elements, and a repetitive description thereof will be omitted.

### First Embodiment

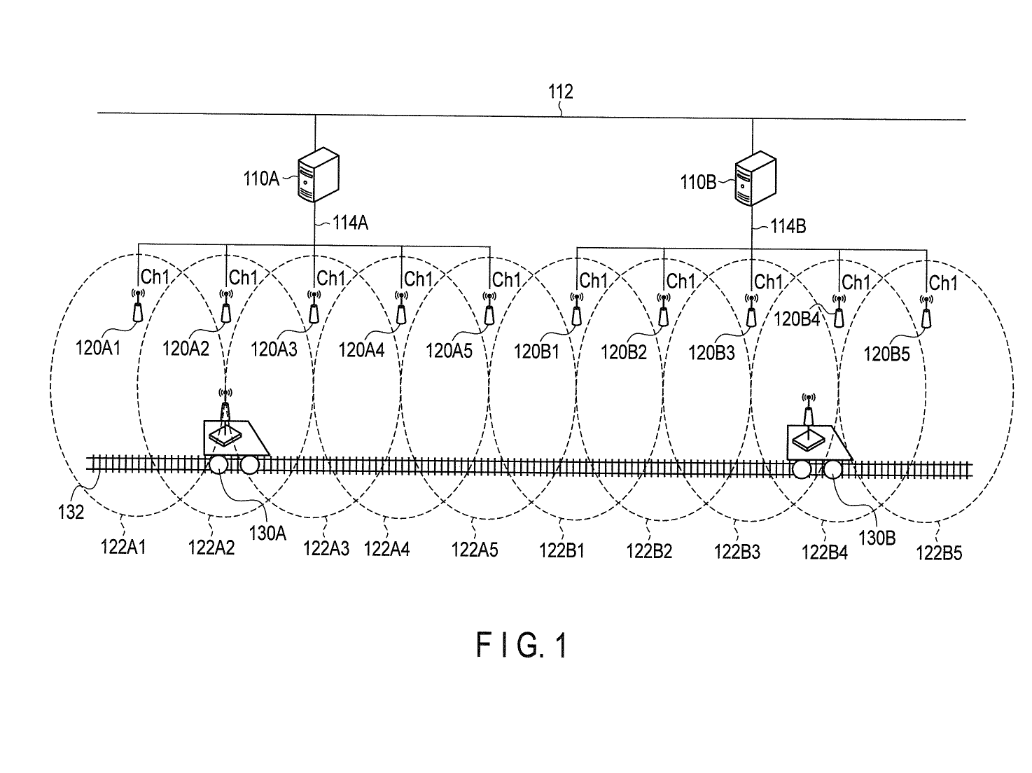

FIG. 1 schematically shows a train control system according to the first embodiment. As shown in FIG. 1, the train control system includes wayside control devices (to be also referred to as failure detection apparatuses) 110, wireless base stations 120, and trains 130 as moving objects. The wayside control devices 110 and wireless base stations 120 are provided on the ground, and the trains 130 move along a track 132. The train control system shown in FIG. 1 controls operation of each train 130 by exchanging information between the wayside control device 110 and the train 130 via the wireless base station 120. In FIG. 1, letters (A, B, and the like) are appended to reference numerals so as to distinguish individual elements. For example, the wayside control devices 110 correspond to wayside control devices 110A and 110B, the wireless base stations 120 correspond to wireless base stations 120A1 to 120A5 and 120B1 to 120B5, and the trains 130 correspond to trains 130A and 130B.

The plurality of wayside control devices 110 are connected to each other via a wired network 112. For example, the wayside control devices 110A and 110E are connected via the wired network 112. The wireless base station 120 is connected to the wayside control device 110 via a wired network 114. For example, the wireless base stations 120A1 to 120A5 are connected to the wayside control device 110A via a wired network 114A, and the wireless base stations 120B1 to 120B5 are connected to the wayside control device 110B via a wired network 114B.

The train 130 is connected to the wireless base station 120 via a wireless network, and communicates with the wayside control device 110 via a wireless communication with the wireless base station 120. For example, the train 130A communicates with the wayside control device 110A via a wireless communication with the wireless base station 120A2.

The overall network including the wired networks 112 and 114 and wireless networks can be implemented by an IP (Internet Protocol) network, and communications can be made by UDP (User Datagram Protocol). The wired networks 112 and 114 are implemented by, for example, Ethernet® compliant with IEEE802.3. The wireless network is implemented by, for example, a WLAN (Wireless Local Area Network) compliant with IEEE802.11.

The wireless base station 120 is arranged along the track 132 so that each train 130 can communicate with at least one wireless base station 120. In this embodiment, a communication area 122 of the wireless base station 120 partially overlaps that of the neighboring wireless base station 120. For example, a communication area 122A4 of the wireless base station 120A4 partially overlaps a communication area 122A3 of the neighboring wireless base station 120A3, and also partially overlaps a communication area 122A5 of the neighboring wireless base station 120A5.

Note that the network configuration which connects the wayside control device 110 and the plurality of wireless base stations 120 is not limited to a star network as shown by the example in FIG. 1, and networks of other configurations may be used. For example, the wayside control device 110 and the plurality of wireless base stations 120 may be connected via a ring network. Also, the network configuration between the wayside control devices 110 may use networks of arbitrary configurations. Furthermore, FIG. 1 shows an example in which five wireless base stations 120 are connected to each wayside control device 110. However, the number of wireless base stations 120 connected to each wayside control device 110 can be arbitrarily planned.

The wireless base station 120 is also called a bridge device, and bridges a communication between the wayside control device 110 and train 130. More specifically, the wireless base station 120 includes a wired communication network interface and wireless communication network interface, and has a function of bridging the wired and wireless networks. Information transmitted from the train 130 to the wayside control device 110 is received by the wireless base station 120 via a wireless channel, is transmitted by this wireless base station 120 to the wayside control device 110 via a wired channel, and is received by the wayside control device 110. Information transmitted from the wayside control device 110 to the train 130 is received by the wireless base station 120 via a wired channel, is transmitted by this wireless base station 120 to the train 130 via a wireless channel, and is received by the train 130.

The wireless base station 120 has a function of an access point (AP) in the WLAN as a function of the wireless network. In this embodiment, the wireless network is constructed by, for example, a frequency channel 1.

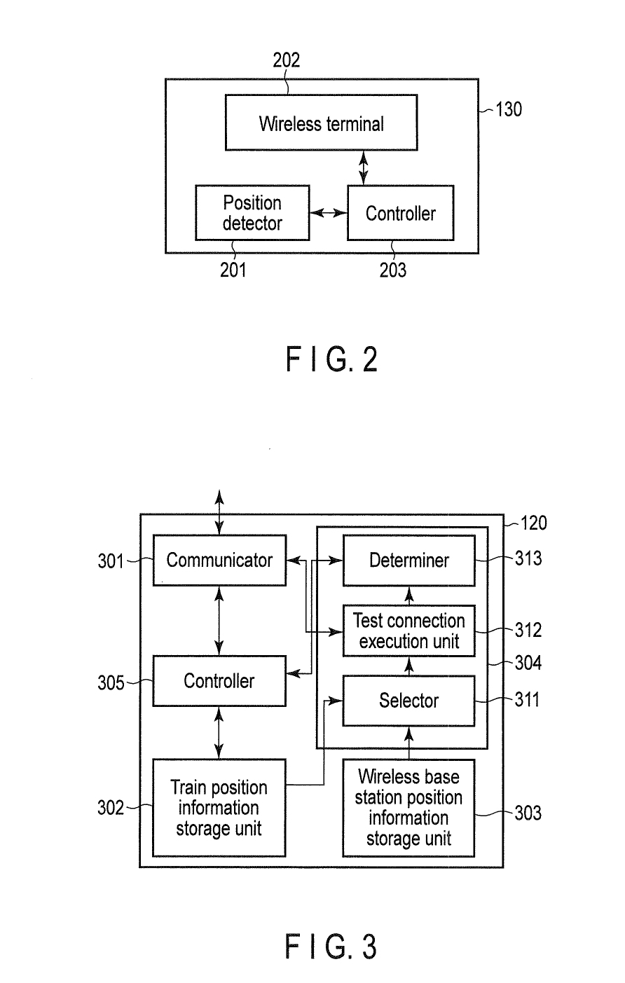

FIG. 2 schematically shows the train 130 according to this embodiment. The train 130 shown in FIG. 2 corresponds to each of the trains 130A and 130B shown in FIG. 1. As shown in FIG. 2, the train 130 includes a position detector 201, wireless terminal 202, and controller 203.

The position detector 201 periodically detects the position of the train 130 (or the wireless terminal 202 mounted on the train 130), and generates position information indicating the detected position. The position detection method is not particularly limited. In one example, the position detector 201 detects an absolute position of the train 130 using a track antenna (not shown) laid on the track 132. In another example, the position detector 201 calculates a speed and relative position of the train 130 using a tacho-generator (not shown) attached to a wheel of the train 130. In still another example, the position detector 201 acquires position information (longitude and latitude) of the train 130 using GPS (Global Positioning System).

The wireless terminal 202 includes an antenna (not shown), and communicates with the wayside control device 110 via wireless communication with the wireless base station 120. The wireless terminal 202 periodically transmits train state information indicating a state of the train 130 to the wayside control device 110, and receives train control information required to control the running of the train 130 from the wayside control device 110. The train state information includes position information which is generated by the position detector 201 and indicates the position of the train 130. The train state information may also include speed information and a train identification number. The train control information includes information indicating a running range of the train 130.

The controller 203 controls the position detector 201 and wireless terminal 202, and controls a driving mechanism (not shown) required to drive the train 130 in accordance with the train control information received from the wayside control device 110.

Note that the information transmission method of the wireless terminal 202 of the train 130 to the wayside control device 110 is not particularly limited as long as the wireless terminal 202 can transmit information to the wayside control device 110. The wireless terminal 202 may use multicast transmission or broadcast transmission to all the wayside control devices 110 or may use unicast transmission to one wayside control device 110. When the unicast transmission is used, the train 130 includes a database (DB) which stores position information indicating the position of each wireless base station 120 and connection information indicating the connection relationship between the wayside control devices 110 and wireless base stations 120, and the controller 203 selects the wayside control device 110 as a transmission partner based on the position of the train 130 with reference to this database.

FIG. 3 schematically shows the wayside control device 110 according to this embodiment. The wayside control device 110 shown in FIG. 3 corresponds to each of the wayside control devices 110A and 110B shown in FIG. 1. As shown in FIG. 3, the wayside control device 110 includes a communicator 301, train position information storage unit 302, wireless base station position information storage unit 303, failure detector 304, and controller 305.

The communicator 301 includes a communication interface for communicating with the train 130 (more specifically, the wireless terminal 202 mounted on the train 130) via the wireless base station 120. For example, the communicator 301 receives the train state information including the position information of the train 130 from the train 130, and transmits the train control information to the train 130. Furthermore, the communicator 301 communicates with another wayside control device 110 via the wired network 112.

The train position information storage unit 302 stores position information indicating the position of each train 130. Furthermore, the train position information storage unit 302 stores information indicating the wireless base station 120 to or with which each train 130 is connected or communicates. In this embodiment, the position of the train 130 matches that of the wireless terminal 202 mounted on the train 130. The position information of the train 130 is shared between the wayside control devices 110. Thus, upon movement of the train 130, the control of that train 130 can be inherited between the wayside control devices 110.

The wireless base station position information storage unit 303 stores position information indicating the positions where the wireless base stations 120 are located. The position information stored in the wireless base station position information storage unit 303 also includes connection information indicating the connection relationship between the wayside control devices 110 and wireless base stations 120. In the example of FIG. 1, the connection information indicates that the wireless base stations 120A1 to 120A5 are connected to the wayside control device 110A, and the wireless base stations 120B1 to 120B5 are connected to the wayside control device 110B.

The failure detector 304 detects an inoperative device as a cause of a system malfunction when the system malfunction has occurred. Note that the system malfunction indicates disruption of a communication between the wayside control device 110 and train 130 for a predetermined period of time. Other examples of the system malfunction may include disappearance of the train 130, a case in which the position of the train 130 has transited in a direction opposite to a traveling direction, and a case in which the train 130 moves at a speed far beyond a moving speed, but the system malfunction is not limited to them. Causes of the system malfunction include a failure of the wireless terminal 202 of the train 130, a failure of the wireless base station 120, a bad wireless communication environment (for example, weakened radio waves due to fading), and the like.

The failure detector 304 includes a selection unit 311, test connection execution unit 312, and determiner 313. The selection unit 311 selects a plurality of wireless base stations 120 to use in test connections which attempt to communicate with the wireless terminal 202 of the train 130 related to the system malfunction. The test connection execution unit 312 executes test connections to the train 130 using the wireless base stations selected by the selection unit 311. The determiner 313 determines a cause of the system malfunction based on the test connection results. As will be described later, for example, if the test connection via any of the wireless base stations selected by the selection unit 311 has filed, the determiner 313 determines that the wireless terminal 202 of the train 130 is inoperative, i.e., has a malfunction.

Note that the failure detector 304 may operate not only when the system malfunction has occurred but also in a normal state. For example, the failure detector 304 may execute a test connection so as to periodically inspect the presence/absence of failures of wireless equipment (for example, the wireless base stations 120, and the wireless terminal 202 of each train 130).

The controller 305 controls the communicator 301, train position information storage unit 302, wireless base station position information storage unit 303, and failure detector 304. Furthermore, the controller 305 controls the train 130 which communicates with this wayside control device 110. For example, upon reception of train state information from the train 130 by the communicator 301, the controller 305 updates the position information of that train 130 in the train position information storage unit 302 by position information included in this train state information. The controller 305 decides a running range of the train 130 with reference to the train position information storage unit 302, and generates train control information.

The operation of the wayside control device 110 will be described below.

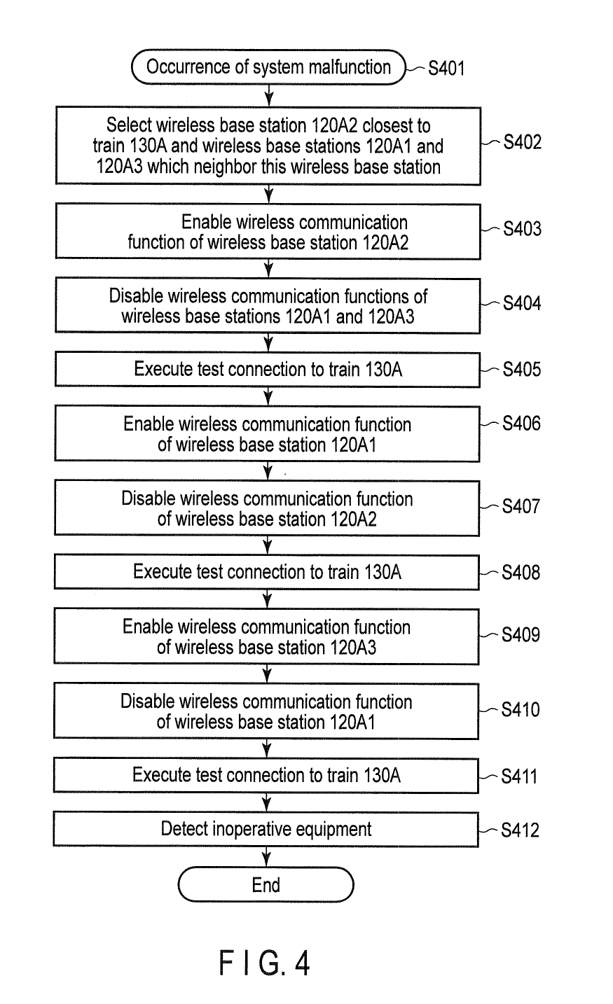

FIG. 4 schematically shows the failure detection sequence according to this embodiment. This embodiment will exemplify a case in which a communication between the wayside control device 110A and train 130A is disrupted, and a cause of that disruption is a failure of the wireless terminal 202 of the train 130A.

In step S401 of FIG. 4, a system malfunction has occurred, and the wayside control device 110A starts an inoperative-equipment search. In step S402, the selection unit 311 of the wayside control device 110A selects a plurality of wireless base stations 120 to use in test connections to the train 130A, the communication with which is disrupted. As the wireless base stations 120 to use in the test connections, for example, a plurality of wireless base stations 120 located within a communication area of the train 130A are selected.

In one example, the selection unit 311 selects the wireless base station 120 closest to the train 130A (more specifically, the wireless terminal 202 of the train 130A) and one or more wireless base stations 120 which neighbor this wireless base station 120 closest to the train 130A. The wireless base station 120 closest to the train 130A can be decided based on the position information of the train 130A with reference to the wireless base station position information storage unit 303, and the neighboring wireless base stations 120 can be decided with reference to the wireless base station position information storage unit 303. For example, when the wireless base station closest to the train 130A is the wireless base station 120A3, two wireless base stations 120A2 and 120A4 may be selected or four wireless base stations 120A1, 120A2, 120A4, and 120A5 may be selected as the wireless base stations which neighbor this wireless base station 120A3. Alternatively, one of the wireless base stations 120A2 and 120A4 may be selected according to the position and/or moving direction of the train 130A.

In another example, the selection unit 311 selects the wireless base station 120 which communicated with the train 130A until just before occurrence of the system malfunction, and a predetermined number of wireless base stations 120 closer to this wireless base station 120. In still another example, the selection unit 311 selects the wireless base station 120 which communicated with the train 130A until just before occurrence of the system malfunction, and one or more wireless base stations 120 which neighbor this wireless base station 120. In yet another example, the selection unit 311 selects a predetermined number of wireless base stations 120 closer to the train 130A.

Note that the selection unit 311 may select all the wireless base stations 120 connected to the wayside control device 110A. For example, when the number of wireless base stations 120 connected to the wayside control device 110A is small, all the wireless base stations 120 can be used in test connections. Alternatively, when the aforementioned periodic inspection is conducted, all the wireless base stations 120 can be used in test connections.

Furthermore, the wayside control device 110 (for example, the wayside control device 110A) can execute test connections using the wireless base stations 120 connected to another wayside control device 110 (for example, the wayside control device 110B). For example, when the wireless base station closest to the train 130A is the wireless base station 120A5, the wayside control device 110A can use the wireless base stations 120A4 and 120A5 and the wireless base station 120B1 connected to the wayside control device 110B in test connections.

In this embodiment, assume that the selection unit 311 selects the wireless base station 120A2 closest to the train 130A, and the wireless base stations 120A1 and 120A3 which neighbor the wireless base station 120A2. The test connection execution unit 312 enables a wireless communication function of the wireless base station 120A2 in step S403, and disables those of the wireless base stations 120A1 and 120A3 in step S404. A method of switching to enable/disable the wireless communication function of the base station may include a method of physically turning on/off a power source, a method of controlling the wireless communication function by software such as a change in MAC address filtering, and a method of controlling the wireless communication function by adjusting the transmission power.

In step S405, the test connection execution unit 312 instructs the communicator 301 to execute a test connection to the train 130A, and obtains a test connection result. In this embodiment, a test connection result indicating that establishment of a communication with the train 130A via the wireless base station 120A2 has failed due to a failure of the wireless terminal 202 of the train 130A, that is, the test connection result indicating that the test connection using the wireless base station 120A2 has failed is obtained. The execution method of the test connection is not particularly limited. In one example, the test connection uses ping. In this case, success of establishment of a communication with the train 130A indicates that the test connection execution unit 312 receives a response signal to ping from the train 130A. In another example, the test connection uses an existing IP network test tool or SNMP (Simple Network Management Protocol). In still another example, the test connection is executed by a method of generating a message dedicated to the test connection. Note that the test connection may be executed a plurality of times to confirm reproducibility.

Subsequently, the test connection execution unit 312 enables the wireless communication function of the wireless base station 120A1 in step S406 and disables that of the wireless base station 120A2 in step S407. In step S408, the test connection execution unit 312 executes a test connection to the train 130A, and obtains a test connection result. In this embodiment, the test connection result indicating that establishment of a communication with the train 130A via the wireless base station 120A1 has failed is obtained.

Furthermore, the test connection execution unit 312 enables the wireless communication function of the wireless base station 120A3 in step S409 and disables that of the wireless base station 120A1 in step S410. In step S411, the test connection execution unit 312 executes a test connection to the train 130A, and obtains a test connection result. In this embodiment, the test connection result indicating that establishment of a communication with the train 130A via the wireless base station 120A3 has failed is obtained.

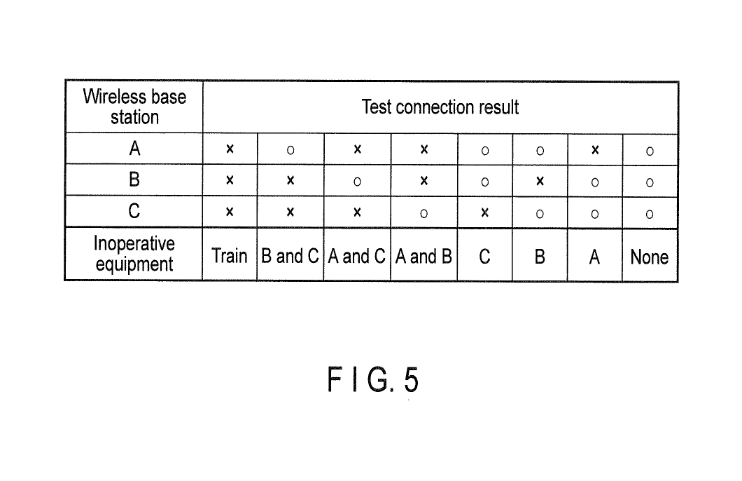

In step S412, the determiner 313 detects inoperative equipment based on the test connection results obtained in steps S405, S408, and S411. FIG. 5 shows the method of detecting inoperative equipment based on the test connection results according to this embodiment. More specifically, FIG. 5 shows an example of a specifying method when the selection unit 311 selects three wireless base stations. In this case, a test connection using a wireless base station A, that using a wireless base station B, and that using a wireless base station C are executed. In FIG. 5, “x” represents that a test connection result indicates a failure, and “∘” represents that a test connection result indicates a success.

As shown in FIG. 5, when all test connection results indicate a failure, it is determined that the train (more specifically, a wireless terminal of the train) is inoperative. When two test connection results indicate a failure, and one test connection result indicates a success, it is determined that two wireless base stations are inoperative. For example, when the test connection using the wireless base station B and that using the wireless base station C have failed, and that using the wireless base station A has succeeded, it is determined that the wireless base stations B and C are inoperative. When one test connection result indicates a failure and two test connection results indicate a success, it is determined that one wireless base station are inoperative. For example, when the test connection using the wireless base station C has failed, and that using the wireless base station A and that using the wireless base station B have succeeded, it is determined that the wireless base station C is inoperative. When all test connection results indicate a success, it is determined that there is no inoperative equipment. In this case, for example, it is determined that a system malfunction is caused by a wireless communication environment. This embodiment has explained the case in which the wayside control device 110 detects a failure of the wireless terminal 202 of the train 130A. Also, the wayside control device 110 can also detect failures of the wireless base stations 120 according to the table shown in FIG. 5.

In this embodiment, since communications with the train 130A cannot be established via the wireless base stations 120A1, 120A2, and 120A3 selected by the selection unit 311, the determiner 313 determines with reference to the table shown in FIG. 5 that the wireless terminal 202 of the train 130A is inoperative. In this manner, a test connection is executed using each of the plurality of wireless base stations 120 selected by the selection unit 311, and inoperative equipment is detected based on a plurality of test connection results, thus improving inoperative-equipment detection accuracy.

As described above, the wayside control device (failure detection apparatus) 110 according to this embodiment selects a plurality of wireless base stations 120 located within a communication area with the train 130 related to a system malfunction, executes a test connection to the train 130 using each selected wireless base station 120, and detects inoperative equipment based on the test connection results. In this manner, the inoperative equipment can be accurately detected.

### Second Embodiment

In the first embodiment, each test connection uses one wireless base station. By contrast, in the second embodiment, each test connection uses a plurality of (for example, two) wireless base stations.

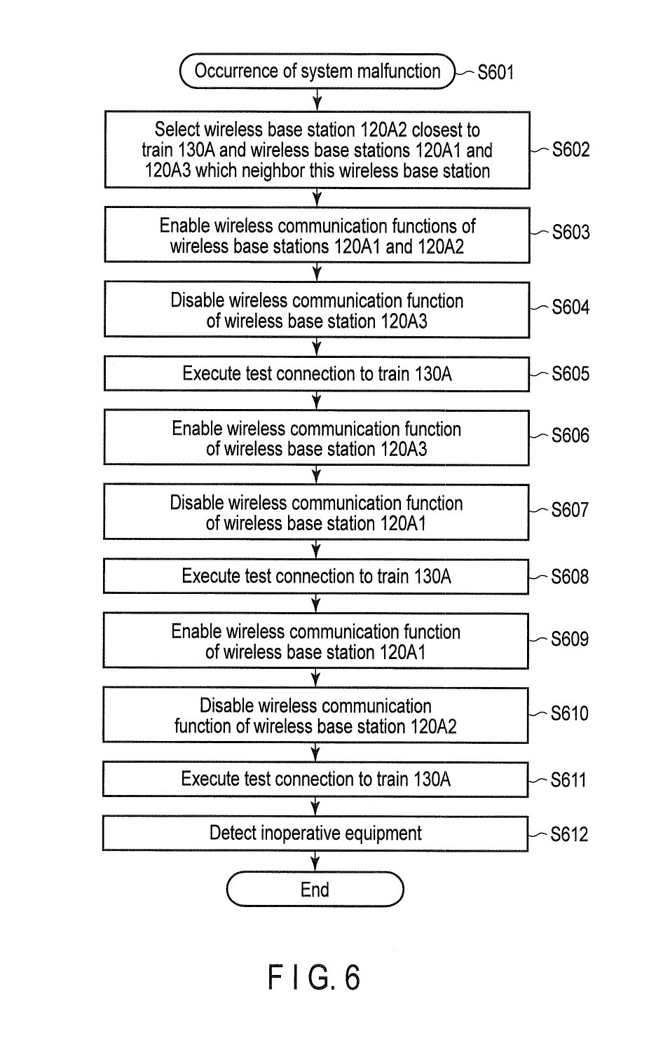

FIG. 6 schematically shows the failure detection sequence according to this embodiment. The second embodiment will exemplify a case in which a communication between the train 130A and wayside control device 110A is disrupted in the train control system shown in FIG. 1, and a cause of that disruption is a failure of the wireless terminal 202 of the train 130A, as in the first embodiment.

In step S601 of FIG. 6, a system malfunction has occurred, and the wayside control device 110A starts an inoperative-equipment search. In step S602, the selection unit 311 of the wayside control device 110A selects a plurality of wireless base stations 120 to use in test connections to the train 130A, the communication with which is disrupted. In this embodiment, assume that the selection unit 311 selects a wireless base station 120A2 closest to the train 130A, and wireless base stations 120A1 and 120A3 which neighbor the wireless base station 120A2.

The test connection execution unit 312 enables wireless communication functions of the wireless base stations 120A1 and 120A2 in step S603, and disables that of the wireless base station 120A3 in step S604. In step S605, the test connection execution unit 312 executes a test connection to the train 130A, and obtains a test connection result. When a communication with the train 130A can be established via at least one of the wireless base stations 120A1 and 120A2, the determiner 313 determines that the test connection has succeeded. In this embodiment, the test connection execution unit 312 obtains a test connection result indicating a communication with the train 130A cannot be established via both the wireless base stations 120A1 and 120A2, that is, a test connection result indicating that test connection using the wireless base stations 120A1 and 120A2 has failed.

The test connection execution unit 312 enables the wireless communication function of the wireless base station 120A3 in step S606 and disables that of the wireless base station 120A1 in step S607. In step S608, the test connection execution unit 312 executes a test connection to the train 130A, and obtains a test connection result. In this embodiment, the test connection execution unit 312 obtains the test connection result indicating that test connection using the wireless base stations 120A2 and 120A3 has failed.

The test connection execution unit 312 enables the wireless communication function of the wireless base station 120A1 in step S609 and disables that of the wireless base station 120A2 in step S610. In step S611, the test connection execution unit 312 executes a test connection to the train 130A, and obtains a test connection result. In this embodiment, the test connection execution unit 312 obtains the test connection result indicating that test connection using the wireless base stations 120A1 and 120A3 has failed.

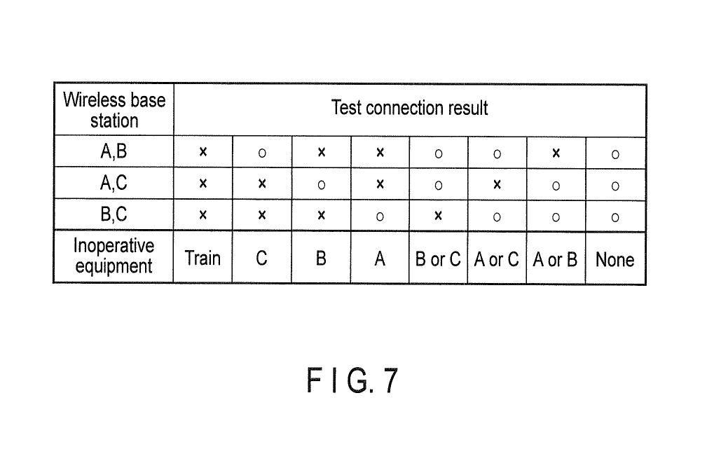

In step S612, the determiner 313 detects inoperative equipment based on the test connection results obtained in steps S605, S608, and S611. FIG. 7 shows the method of detecting inoperative equipment based on the test connection results according to this embodiment. More specifically, FIG. 7 shows an example of a determination method when three wireless base stations within a communication area with the train are selected. In this case, a test connection using wireless base stations A and B, that using wireless base stations A and C, and that using wireless base stations B and C are executed. In FIG. 7, “x” represents that a test connection result indicates a failure, and “∘” represents that a test connection result indicates a success.

As shown in FIG. 7, when all test connection results indicate a failure, it is determined that the train (more specifically, a wireless terminal of the train) is inoperative. When two test connection results indicate a failure, and one test connection result indicates a success, it is determined that one wireless base station is inoperative. For example, when the test connection using the wireless base stations A and C and that using the wireless base stations B and C have failed, and that using the wireless base stations A and B has succeeded, it is determined that the wireless base station C is inoperative. When one test connection result indicates a failure and two test connection results indicate a success, it is determined that one wireless base station is inoperative. For example, when the test connection using the wireless base stations B and C has failed, and that using the wireless base stations A and B and that using the wireless base stations A and C have succeeded, it is determined that the wireless base station B or C is inoperative. When all test connection results indicate a success, it is determined that there is no inoperative equipment.

In this embodiment, since all the test connection results indicate a failure, the determiner 313 determines with reference to the table shown in FIG. 7 that the wireless terminal 202 of the train 130A is inoperative.

As described above, the wayside control device according to this embodiment uses a plurality of wireless base stations in each test connection. Thus, since a plurality of paths are assured in each test connection, even when any equipment is inoperative at an inoperative-equipment detection timing, inoperative equipment can be detected. For example, when any wireless base station is inoperative at the inoperative-equipment detection timing, the determiner can determine a failure of the wireless terminal of the train by checking whether or not all the test connection results indicate a failure.

### Third Embodiment

The third embodiment uses a plurality of (for example, two) wireless base stations in each test connection as in the second embodiment. This embodiment will explain an example in which a system malfunction occurs due to a failure of a wireless base station which communicates with a train.

This embodiment will exemplify a case in which a communication between the train 130B and wayside control device 110B is disrupted in the train control system shown in FIG. 1, and a cause of this disruption is a failure of the wireless base station 120B4. The failure detection sequence according to this embodiment is the same as that described using FIG. 6 in the second embodiment.

The selection unit 311 of the wayside control device 110B selects a plurality of wireless base stations to use in test connections to the train 130B. In this embodiment, assume that the selection unit 311 selects a wireless base station 120B4 closest to the train 130B, and the wireless base stations 120B3 and 120B5 which neighbor the wireless base station 120B4.

A test connection execution unit 312 enables wireless communication functions of the wireless base stations 120B3 and 120B4, and disables that of the wireless base station 120B5. The test connection execution unit 312 executes a test connection to the train 130B, and obtains a test connection result. In this embodiment, the test connection execution unit 312 obtains the test connection result indicating that establishment of a communication via the wireless base station 120B3 has succeeded.

Subsequently, the test connection execution unit 312 enables the wireless communication function of the wireless base station 120B5 and disables that of the wireless base station 120B3. The test connection execution unit 312 executes a test connection to the train 130B, and obtains a test connection result. In this embodiment, the test connection execution unit 312 obtains the test connection result indicating that establishment of a communication via the wireless base station 120B5 has succeeded.

Furthermore, the test connection execution unit 312 enables the wireless communication function of the wireless base station 120B3 and disables that of the wireless base station 120B4. The test connection execution unit 312 executes a test connection to the train 130B, and obtains a test connection result. In this embodiment, the test connection execution unit 312 obtains the test connection result indicating that establishment of a communication via the wireless base station 120B3 has succeeded.

The determiner 313 detects inoperative equipment based on the obtained test connection results. Since all the test connection results indicate a success, the determiner 313 determines no inoperative equipment according to the table shown in FIG. 7. However, since a communication via the wireless base station 120B4 closest to the train 130B has not been made yet, finally, the test connection execution unit 312 enables the wireless communication function of the wireless base station 120B4, disables those of the wireless base stations 120B3 and 120B5, and then executes a test connection. As a result of the test connection, when establishment of a communication with the train 130B has failed, the determiner 313 determines that the wireless base station 120B4 is inoperative.

As described above, the wayside control device according to this embodiment can detect a failure of the wireless base station while minimizing function breakdown times of the wireless base stations in the inoperative-equipment detection.

### Fourth Embodiment

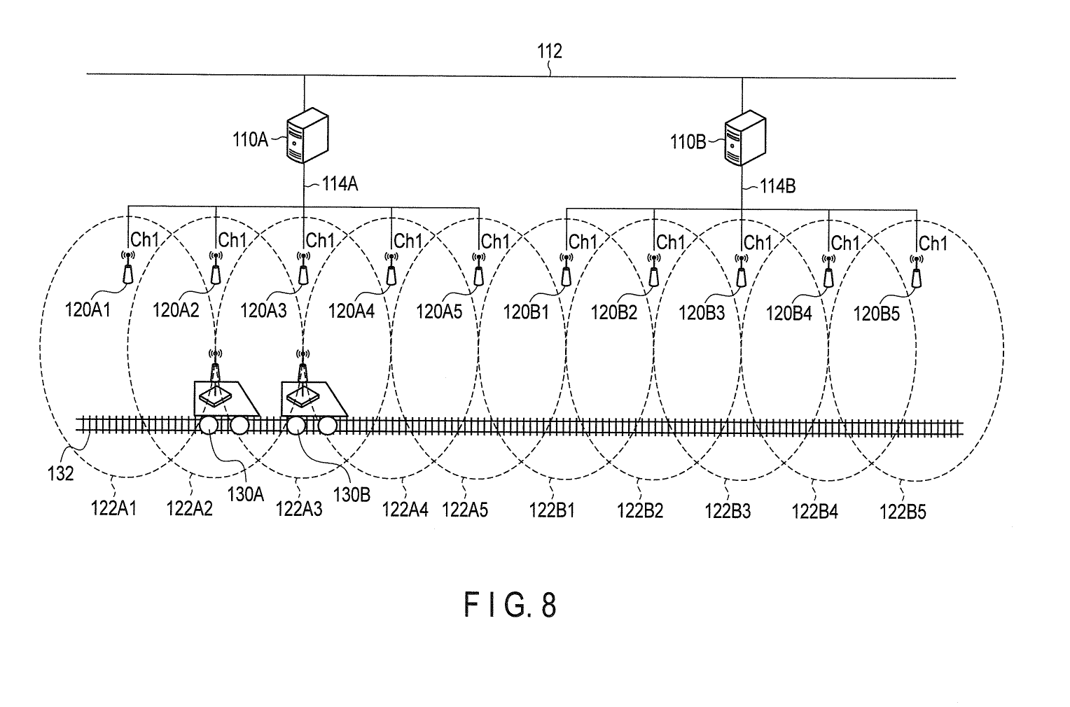

The fourth embodiment will explain a method of detecting inoperative equipment by a wayside control device in a situation in which a plurality of trains are running with a short distance between them. This embodiment will explain an example in which a system malfunction occurs due to a failure of the wireless terminal 202 of the train 130B in a situation in which two trains 130A and 130B are running to be close to each other, as shown in FIG. 8. In the example shown in FIG. 8, a wireless base station closest to the train 130A is the wireless base station 120A2, and that closest to the train 130B is the wireless base station 120A3.

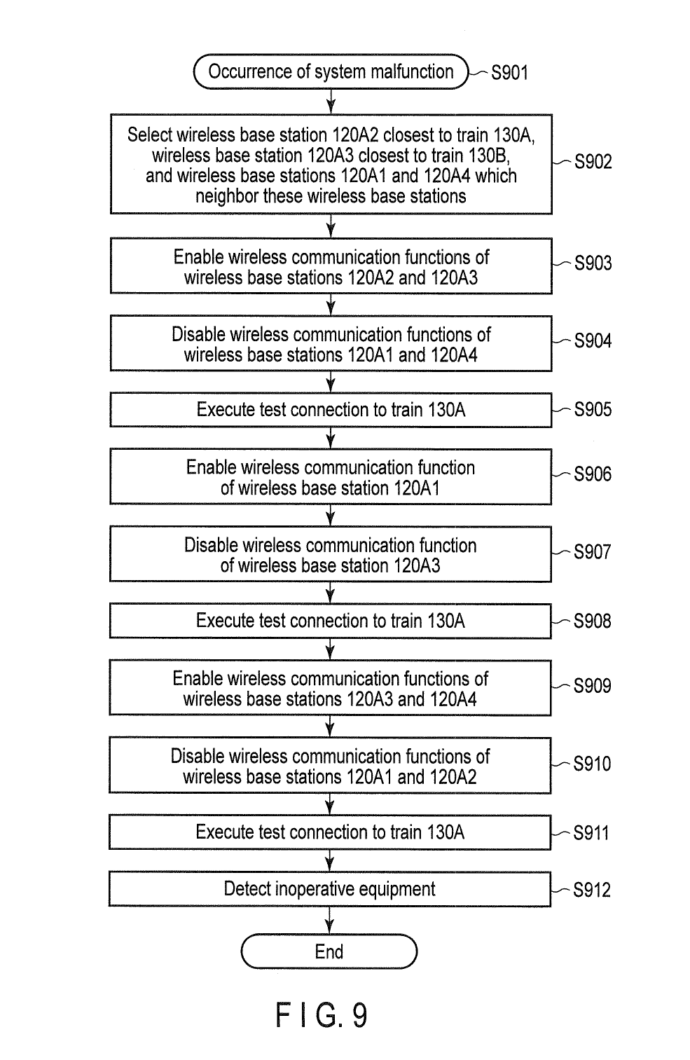

FIG. 9 schematically shows the failure detection sequence according to this embodiment. In step S901 of FIG. 9, a communication between the wayside control device 110A and the train 130E is disrupted due to a failure of the wireless terminal 202 of the train 130B, and the controller 305 of the wayside control device 110A detects occurrence of a system malfunction after an elapse of a predetermined period of time.

In step S902, the selection unit 311 selects a plurality of wireless base stations 120 to use in test connections. In this embodiment, the selection unit 311 judges that the trains 130A and 130B are close to each other based on the relationship among position information of the train 130A, that of the train 130B, and the wireless base stations closest to the respective trains. The selection unit 311 selects the wireless base station 120A2 closest to the train 130A, the wireless base station 120A3 closest to the train 130B, and the wireless base stations 120A1 and 120A4, which neighbor these wireless base stations 120A2 and 120A3.

In step S903, when the plurality of trains 130A and 130B are close to each other, a test connection execution unit 312 enables wireless communication functions of the wireless base stations 120A2 and 120A3, which are respectively closest to the trains 130A and 130B. In step S904, the test connection execution unit 312 disables wireless communication functions of the wireless base stations 120A1 and 120A4. In step S905, the test connection execution unit 312 executes test connections to the trains 130A and 130B, and obtains a test connection result. In this embodiment, a determiner 313 obtains a test connection result indicating that establishment of a communication with the train 130A via the wireless base station 120A2 has succeeded, and that of a communication with the train 130B has failed.

The test connection execution unit 312 enables the wireless communication function of the wireless base station 120A1 in step S906, and disables that of the wireless base station 120A3 in step S907. In step S908, the test connection execution unit 312 executes test connections to the trains 130A and 130B, and obtains a test connection result. In this embodiment, the determiner 313 obtains a test connection result indicating that establishment of a communication with the train 130A via the wireless base station 120A1 has succeeded, and that of a communication with the train 130B has failed.

Subsequently, the test connection execution unit 312 enables the wireless communication functions of the wireless base stations 120A3 and 120A4 in step S909, and disables those of the wireless base stations 120A1 and 120A2 in step S910. In step S911, the test connection execution unit 312 executes test connections to the trains 130A and 130B, and obtains a test connection result. In this embodiment, the test connection execution unit 312 obtains a test connection result indicating that establishment of a communication with the train 130A via the wireless base station 120A3 has succeeded, and that of a communication with the train 130B has failed.

In step S912, the determiner 313 detects inoperative equipment based on the test connection results obtained in steps S905, S908, S911. In this embodiment, since all the test connection results related to the train 130A indicate a success, and those related to the train 130B indicate a failure, the determiner 313 determines that the wireless terminal 202 of the train 130A is normal, and that of the train 130B is inoperative.

As described above, even in a situation in which a plurality of trains are close to each other, the wayside control device according to this embodiment uses a plurality of wireless base stations in each test connection, thereby detecting inoperative equipment even when any equipment is operative at an inoperative-equipment detection timing. Furthermore, since test connections are executed by efficiently using the plurality of wireless base stations, inoperative equipment can be detected without prolonging a detection time.

### Fifth Embodiment

The fifth embodiment will explain a failure detection method when a plurality of wireless base stations are located at each place so as to provide redundancy.

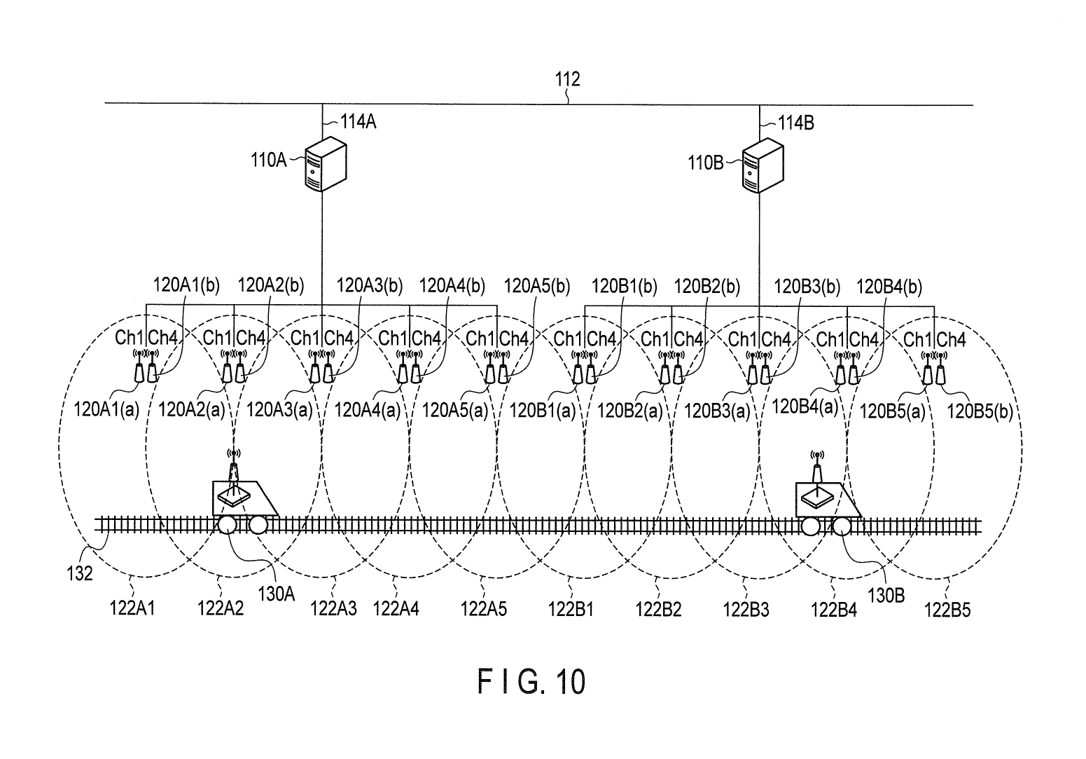

FIG. 10 schematically shows a train control system according to the fifth embodiment. In this embodiment, as shown in FIG. 10, two wireless base stations 120 are located at each place, and these two wireless base stations 120 make communications using different frequency channels. For example, a wireless base station 120A1(a) which communicates using a frequency channel 1 and a wireless base station 120A1(b) which communicates using a frequency channel 4 are located at the same place. The system operation is made using the wireless base station 120 of the frequency channel 1 in a normal state, and both the wireless base stations 120 of the frequency channels 1 and 4 are used upon failure detection.

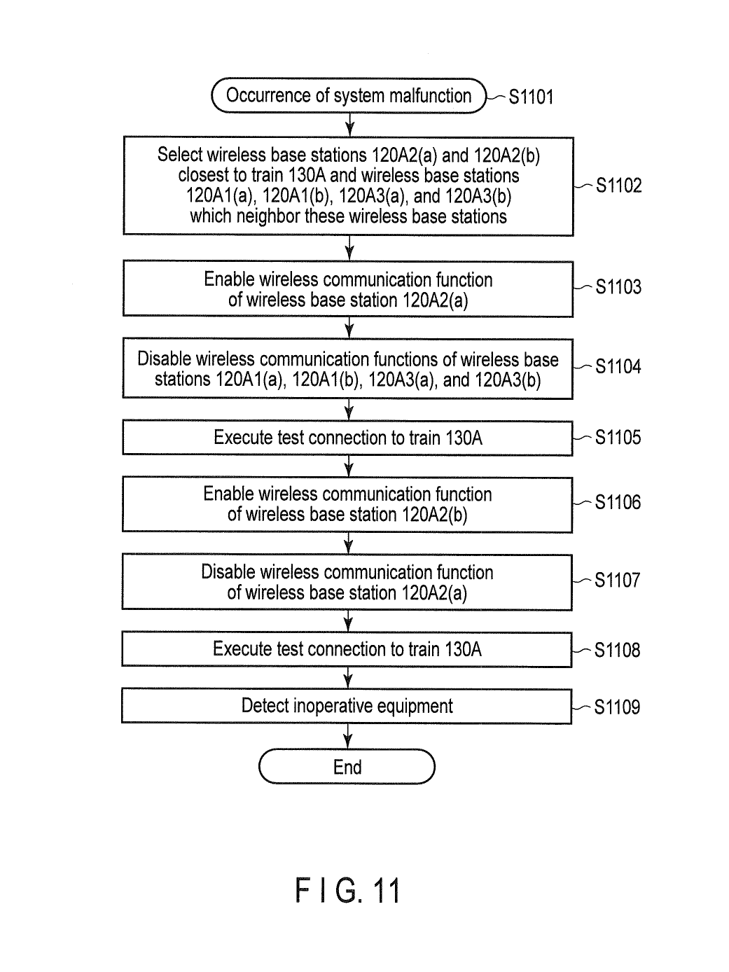

FIG. 11 schematically shows a failure detection method according to this embodiment. This embodiment will explain an example in which the train 130A communicates with the wayside control device 110A via a wireless communication with a wireless base station 120A2(a), but a system malfunction occurs due to a failure of the wireless terminal 202 of the train 130A.

In step S1101 of FIG. 11, the controller 305 of the wayside control device 110A detects occurrence of the system malfunction. In step S1102, the selection unit 311 of the wayside control device 110A selects wireless base stations 120A2(a) and 120A2(b) closest to the train 130A, the communication with which is disrupted, and wireless base stations 120A1(a), 120A1(b), 120A3(a), and 120A3(b), which neighbor these wireless base stations.

The test connection execution unit 312 enables a wireless communication function of the wireless base station 120A2(a) in step S1103, and disables those of the wireless base stations 120A1(a), 120A1(b), 120A2(b), 120A3(a), and 120A3(b) in step S1104. In step S1105, the test connection execution unit 312 executes a test connection to the train 130A in this state. In this embodiment, the test connection execution unit 312 obtains a test connection result indicating that establishment of a communication has failed.

Subsequently, the test connection execution unit 312 enables a wireless communication function of the wireless base station 120A2(b) in step S1106, and disables that of the wireless base station 120A2(a) in step S1107. In step S1108, the test connection execution unit 312 executes a test connection to the train 130A in this state. In this embodiment, the test connection execution unit 312 obtains a test connection result indicating that establishment of a communication has failed.

In step S1109, the determiner 313 determines a failure of the wireless terminal 202 of the train 130A from the test connection results obtained in steps S1105 and S1108.

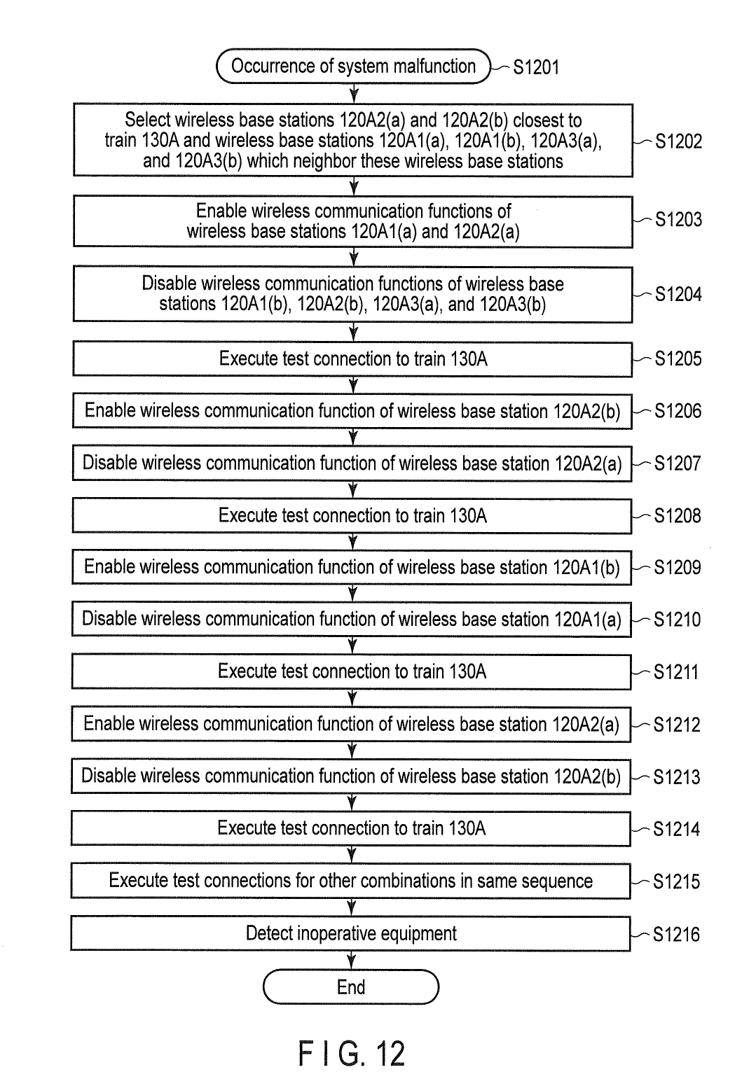

Note that the wayside control device 110A may use, in test connections, the wireless base stations 120A1(a), 120A1(b), 120A3(a), and 120A3(b), which neighbor the wireless base stations 120A2(a) and 120A2(b). In this case, for example, the wayside control device 110A executes test connections using all combinations of two wireless base stations 120 located at different places, as described in the second embodiment. This sequence will be described in detail below with reference to FIG. 12.

In step S1201 of FIG. 12, the controller 305 of the wayside control device 110A detects occurrence of the system malfunction. In step S1202, the selection unit 311 of the wayside control device 110A selects wireless base stations 120A2(a) and 120A2(b) closest to the train 130A, the communication with which is disrupted, and wireless base stations 120A1(a), 120A1(b), 120A3(a), and 120A3(b), which neighbor these wireless base stations.

The test connection execution unit 312 enables wireless communication functions of the wireless base stations 120A1(a) and 120A2(a) in step S1203, and disables those of the wireless base stations 120A1(b), 120A2(b), 120A3(a), and 120A3(b) in step S1204. In step S1205, the test connection execution unit 312 executes a test connection to the train 130A in this state.

Subsequently, the test connection execution unit 312 enables the wireless communication function of the wireless base station 120A2(b) in step S1206, and disables that of the wireless base station 120A2(a) in step S1207. In step S1208, the test connection execution unit 312 executes a test connection to the train 130A in this state.

Furthermore, the test connection execution unit 312 enables the wireless communication function of the wireless base station 120A1(b) in step S1209, and disables that of the wireless base station 120A1(a) in step S1210. In step S1211, the test connection execution unit 312 executes a test connection to the train 130A in this state.

The test connection execution unit 312 enables the wireless communication function of the wireless base station 120A2(a) in step S1212, and disables that of the wireless base station 120A2(b) in step S1213. In step S1214, the test connection execution unit 312 executes a test connection to the train 130A in this state.

In steps S1203 to S1214 described above, the test connections are executed using combinations of the wireless base stations 120A1(a), 120A1(b), 120A2(a), and 120A2(b), which are located at two places. In step S1215, in the same manner as the sequence from step S1203 to step S1214, test connections are executed using combinations of the wireless base stations 120A1(a), 120A1(b), 120A3(a), and 120A3(b), which are located at two places, and also using combinations of the wireless base stations 120A2(a), 120A2(b), 120A3(a), and 120A3(b), which are located at two places. In step S1216, the determiner 313 detects inoperative equipment based on the obtained test connection results.

According to the sequence shown in FIG. 12, although a time required to detect inoperative equipment is prolonged since the number of combinations of the wireless base stations to use in test connections increases, the failure detection accuracy can be further improved.

As described above, the wayside control device according to this embodiment detects inoperative equipment by arranging the wireless base station for the system operation and the wireless base station for failure detection at each place, and using diversity. Thus, the failure detection accuracy can be further improved.

### Sixth Embodiment

The sixth embodiment will explain a failure detection method when each wireless base station includes a plurality of antennas.

In this embodiment, each wireless base station 120 shown in FIG. 1 includes two antennas (a) and (b) (not shown). In each test connection, one antenna of each of the two wireless base stations 120 is used. By operating a plurality of antennas in the wireless base stations, the failure detection accuracy can be improved.

Note that the wireless terminal 202 of the train 130 may include a plurality of antennas, or both the wireless base station 120 and the wireless terminal 202 of the train 130 may include a plurality of antennas in place of the case in which each wireless base station 120 includes the plurality of antennas.

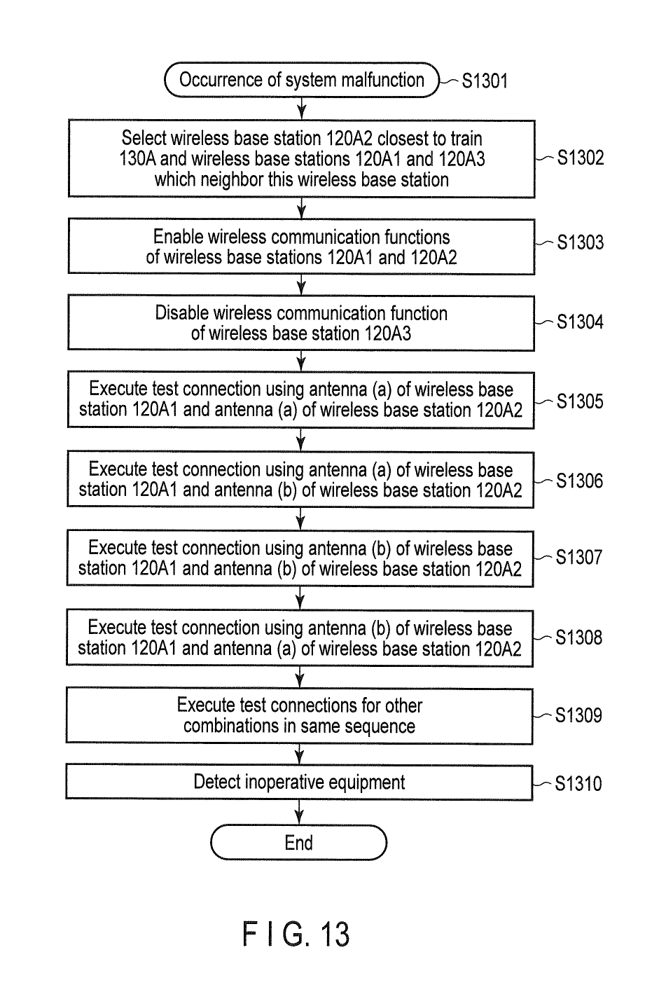

The failure detection sequence according to this embodiment will be described in detail below with reference to FIG. 13. In the failure detection sequence according to this embodiment, a selection method of a pair of wireless base stations used in each test connection is the same as that in the failure detection sequence (shown in FIG. 6) according to the second embodiment.

In step S1301 of FIG. 13, the controller 305 of the wayside control device 110A detects occurrence of a system malfunction. In step S1302, the selection unit 311 selects the wireless base station 120A2 closest to the train 130A, and the wireless base stations 120A1 and 120A2 which neighbor this wireless base station 120A2. A test connection execution unit 312 enables wireless communication functions of the wireless base stations 120A1 and 120A2 in step S1303, and disables that of the wireless base station 120A3 in step S1304.

In step S1305, the test connection execution unit 312 executes a test connection to the train 130A using the antenna (a) of the wireless base station 120A1 and the antenna (a) of the wireless base station 120A2. In step S1306, test connection execution unit 312 executes a test connection to the train 130A using the antenna (a) of the wireless base station 120A1 and the antenna (b) of the wireless base station 120A2. In step S1307, the test connection execution unit 312 executes a test connection to the train 130A using the antenna (b) of the wireless base station 120A1 and the antenna (b) of the wireless base station 120A2. In step S1308, the test connection execution unit 312 executes a test connection to the train 130A using the antenna (b) of the wireless base station 120A1 and the antenna (a) of the wireless base station 120A2.

In step S1309, the test connection execution unit 312 executes the same processes in step S1305 to S1308 for other combinations. More specifically, the test connection execution unit 312 executes test connections by selecting the antennas for a pair of the wireless base stations 120A2 and 120A3 and that of the wireless base stations 120A1 and 120A3. In step S1310, a determiner 313 detects inoperative equipment based on test connection results.

As described above, the wayside control device according to this embodiment can execute accurate failure detection using antenna selection diversity.

### Seventh Embodiment

The seventh embodiment will explain a case in which a failure detection apparatus is applied to, for example, a robot control system arranged in a factory.

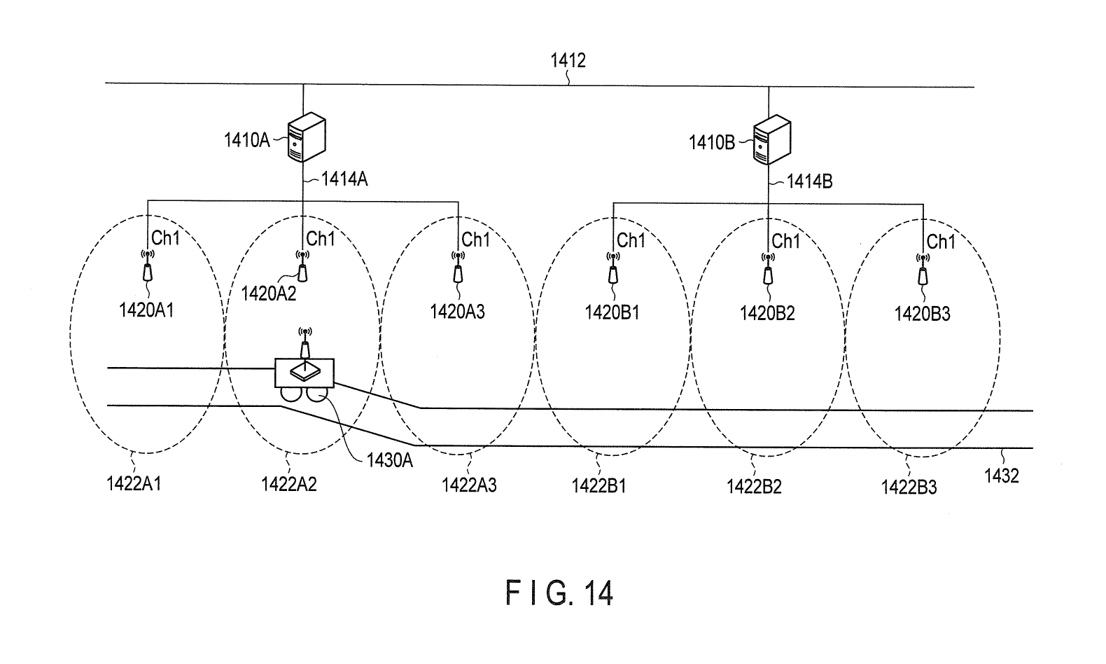

FIG. 14 schematically shows a robot control system according to the seventh embodiment. As shown in FIG. 14, the robot control system includes control devices (to be also referred to as failure detection apparatuses) 1410, bridge devices 1420, and a moving robot 1430 which moves along a lane 1432. In this embodiment, the bridge devices 1420 are arranged along the lane 1432 so that their communication areas 1422 do not overlap each other. In the robot control system shown in FIG. 14, by exchanging information between the control device 1410 and moving robot 1430 via the bridge device 1420, the control device 1410 controls the moving robot 1430. In FIG. 14, letters (A, B, and the like) are appended to reference numerals so as to distinguish individual elements.

The control devices 1410 are connected to each other via a wired network 1412. The bridge devices 1420 are connected to the control devices 1410 via wired networks 1414. The moving robot 1430 is connected to each bridge device 1420 via a wireless network, and communicates with each control device 1410 via a wireless communication with the bridge device 1420. Since the control device 1410, bridge device 1420, and moving robot 1430 shown in FIG. 14 respectively have the same arrangements as those of the wayside control device 110, wireless base station 120, and train 130 shown in FIG. 1, a detailed description of the control device 1410, bridge device 1420, and moving robot 1430 will not be given.

The operation of the control device 1410 will be described below.

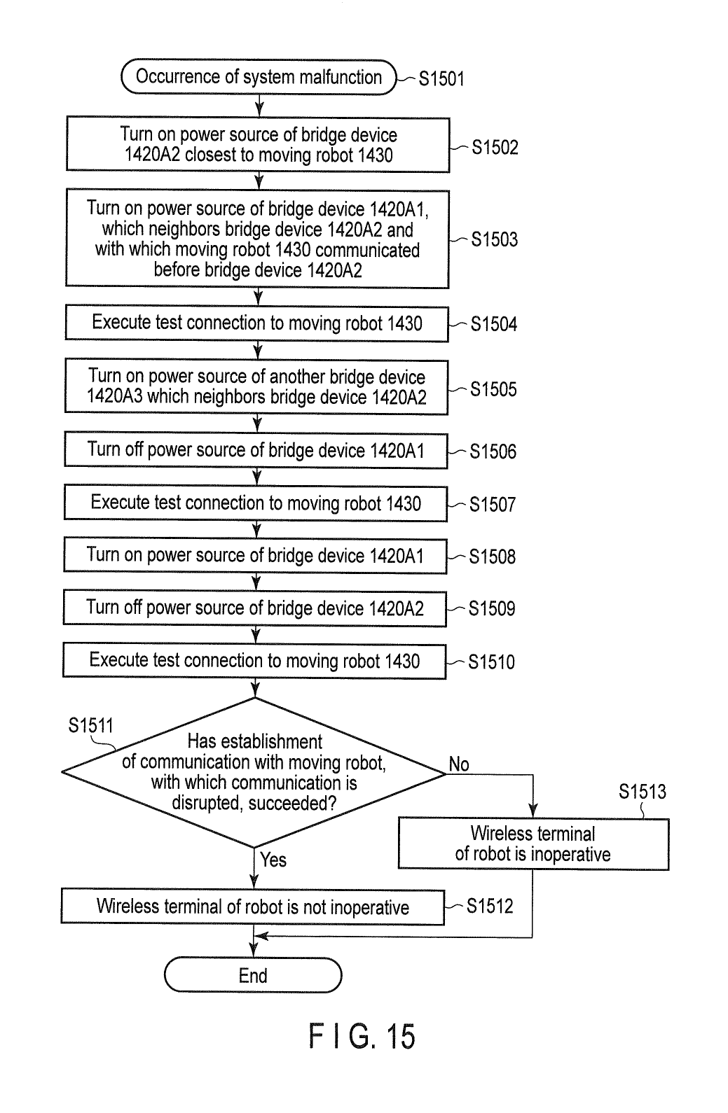

FIG. 15 schematically shows the failure detection sequence according to this embodiment. This embodiment will explain an example in which the operation of the moving robot 1430 is stopped in a situation shown in FIG. 14, and a cause of the stop is a failure of a wireless terminal mounted on the moving robot 1430.

In step S1501 of FIG. 15, a communication between the moving robot 1430 and control device 1410A is disrupted, and the control device 1410A detects occurrence of a system malfunction. The control device 1410A turns on a power source of the bridge device 1420A2 to which the moving robot 1430 was wirelessly connected until just before the system malfunction in step S1502, and turns on a power source of the bridge device 1420A1 to which the moving robot 1430 was wirelessly connected before the bridge device 1420A2 in step S1503. The bridge device 1420A1 neighbors the bridge device 1420A2, and is located on the side opposite to the traveling direction of the moving robot 1430. In step S1504, the control device 1410A executes a test connection to the moving robot 1430, and holds a test connection result.

In step S1505, the control device 1410A turns on a power source of the bridge device 1420A3, which neighbors the bridge device 1420A2 and is located on the side of the traveling direction of the moving robot 1430. In step S1506, the control device 1410A turns off the power source of the bridge device 1420A1. In step S1507, the control device 1410A executes a test connection to the moving robot 1430, and holds a test connection result.

The control device 1410A turns on the power source of the bridge device 1420A1 in step S1508, and turns off that of the bridge device 1420A2 in step S1509. In step S1510, the control device 1410A executes a test connection to the moving robot 1430, and holds a test connection result.

It is determined in step S1511 whether or not establishment of communications with the moving robot 1430 has succeeded as a result of the test connections. If establishment of the communications with the moving robot 1430 has succeeded, the process advances to step S1512, and the control device 1410A determines that the wireless terminal of the moving robot 1430 is not inoperative. On the other hand, if establishment of communications with the moving robot 1430 has failed in all the test connections, the process advances to step S1513, and the control device 1410A determines that the wireless terminal of the moving robot 1430 is operative.

As described above, since the test connections are executed using the bridge devices 1420 which are likely to establish communications with the moving robot 1430, whether a communication failure has occurred due to a temporarily weakened radio field intensity caused by fading or the like, or due to a failure of any wireless equipment (for example, the wireless terminal of the moving robot 1430 or the bridge device 1420) can be identified.

In this embodiment, the two bridge devices 1420 are used in each test connection. Also, in order to detect a failure of the bridge device 1420, a test connection using one bridge device 1420 may be further executed.

In at least one of the aforementioned embodiments, a plurality of bridge devices are connected to a failure detection apparatus (for example, a wayside control device or control device) by wired connections, and the failure detection apparatus communicates with a wireless terminal mounted on a moving object (for example, a train or moving robot) using the plurality of bridge devices. When a system malfunction has occurred, the failure detection apparatus executes test connections by individually using two or more wireless base stations or by combining them. In this manner, wireless equipment as a cause of the system malfunction can be detected.

Instructions in the processing sequences described in the aforementioned embodiment can be executed based on a program as software. A general-purpose computer system stores this program in advance and loads the stored program, thus obtaining the same effects as those by the failure detection apparatus of the aforementioned embodiment. The instructions described in the aforementioned embodiment are recorded, as a program which can be executed by a computer, in a magnetic disk (flexible disk, hard disk, etc.), optical disk (CD-ROM, CD-R, CD-RW, DVD-ROM, DVD±R, DVD±RW, etc.), semiconductor memory, or similar recording medium. A storage format of a recording medium is not particularly limited as long as that recording medium is readable by a computer or embedded system. The computer loads the program from this recording medium, and controls a CPU to execute instructions described in the program based on this program, thus implementing the same operation as the failure detection apparatus of the aforementioned embodiment. Of course, the computer may acquire or load the program via a network.

Also, an OS (Operating System), database management software, MW (middleware) for a network, or the like, which runs on a computer, may execute some of the processes required to implement this embodiment based on instructions of a program installed from the recording medium in a computer or embedded system.

Furthermore, the recording medium of this embodiment is not limited to a medium independently of a computer or embedded system, and includes a recording medium, which stores or temporarily stores a program downloaded via a LAN, Internet, or the like.

The number of recording media is not limited to one, and the recording medium of this embodiment includes the case in which the processing of this embodiment is executed from a plurality of media. That is, the medium configuration is not particularly limited.

Note that the computer or embedded system of this embodiment is used to execute respective processes of this embodiment based on the program stored in the recording medium, and may have an arbitrary arrangement such as a single apparatus (for example, a personal computer, microcomputer, etc.), or a system in which a plurality of apparatuses are connected via a network.

The computer of this embodiment is not limited to a personal computer, and includes an arithmetic processing device, microcomputer, or the like included in an information processing apparatus, and is a generic name of a device and apparatus, which can implement the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A failure detection apparatus comprising:
a communicator configured to communicate with a wireless terminal mounted on a moving object via at least one of first bridge devices located at predetermined positions;
a selector configured to select second bridge devices from the first bridge devices;
an execution unit configured to execute test connections to the wireless terminal using the second bridge devices; and
a determiner configured to determine that the wireless terminal is inoperative if the test connection via any of the second bridge devices has failed.

2. The apparatus according to claim 1, wherein the communicator receives position information indicating a position of the wireless terminal from the wireless terminal, and
the selector selects, as the second bridge devices, a first bridge device closest to the wireless terminal and one or more first bridge devices which neighbor the first bridge device based on the position information.

3. The apparatus according to claim 1, wherein the communicator receives position information indicating a position of the wireless terminal from the wireless terminal, and
the selector selects, as the second bridge devices, a predetermined number of first bridge devices closer to the wireless terminal based on the position information.

4. The apparatus according to claim 1, wherein the selector selects, as the second bridge devices, a first bridge device with which the wireless terminal communicated until just before and a predetermined number of first bridge devices closer to the first bridge device from the first bridge devices.

5. The apparatus according to claim 1, wherein the execution unit executes a test connection while enabling a wireless communication function of any one of the second bridge devices.

6. The apparatus according to claim 1, wherein the execution unit executes a test connection while enabling wireless communication functions of any two of the second bridge devices.

7. The apparatus according to claim 1, wherein communication areas of the first bridge devices do not overlap each other.

8. The apparatus according to claim 1, further comprising a storage unit configured to store position information indicating the predetermined positions where the first bridge devices is located.

9. The apparatus according to claim 1, wherein the communicator is connected to the first bridge devices by wired connections.

10. A failure detection method comprising:
communicating with a wireless terminal mounted on a moving object via at least one of first bridge devices located at predetermined positions;
selecting second bridge devices from the first bridge devices;
executing test connections to the wireless terminal using the second bridge devices; and
determining that the wireless terminal is inoperative if the test connection via any of the second bridge devices has failed.

11. The method according to claim 10, wherein the communicating comprises receiving position information indicating a position of the wireless terminal from the wireless terminal, and
the selecting comprises selecting, as the second bridge devices, a first bridge device closest to the wireless terminal and one or more first bridge devices which neighbor the first bridge device based on the position information.

12. The method according to claim 10, wherein the communicating comprises receiving position information indicating a position of the wireless terminal from the wireless terminal, and
the selecting comprises selecting, as the second bridge devices, a predetermined number of first bridge devices closer to the wireless terminal based on the position information.

13. The method according to claim 10, wherein the selecting comprises selecting, as the second bridge devices, a first bridge device with which the wireless terminal communicated until just before and a predetermined number of first bridge devices closer to the first bridge device from the first bridge devices.

14. The method according to claim 10, wherein the executing comprises executing a test connection while enabling a wireless communication function of any one of the second bridge devices.

15. The method according to claim 10, wherein the executing comprises executing a test connection while enabling wireless communication functions of any two of the second bridge devices.

16. The method according to claim 10, wherein communication areas of the first bridge devices do not overlap each other.

17. The method according to claim 10, further comprising preparing a storage unit configured to store position information indicating the predetermined positions where the first bridge devices is located.
